(19) United States
(12) Patent Application Publication
(10) Pub. No.: US 2009/0233695 A1
(43) Pub. Date: Sep. 17, 2009

(54) Slot Machine And Playing Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/135,669

(22) Filed: Jun. 9, 2008

Related U.S. Application Data
(60) Provisional application No. 61/035,530, filed on Mar. 11, 2008.

(51) Int. Cl. A63F 13/00

(52) U.S. Cl. 463/21

(57) ABSTRACT

A slot machine of the present invention includes: a display device on which plural types of symbols are arranged; at least one memory; and a controller. The controller is configured to: store at least one item of predetermined numeric range information in the memory; randomly determine a specific numeric value from among the predetermined numeric range information stored in the memory and store the determined specific numeric value in the memory; automatically rearrange the plural types of symbols arranged on the display device; judge whether or not a state of rearrangement of predetermined symbols is established on the symbol-rearranged display device; in a case where it is judged that the state of rearrangement of the predetermined symbols is established as a result of the above judgment; count the state of rearrangement of the predetermined symbols as one count and store the counted number of times in the memory; award prizes having predetermined values in a case where the stored number of times in establishing the state of rearrangement of the predetermined symbols reaches the specific numeric value as a result of repeating games.

### CROSS-REFERENCE TO RELATED APPLICATIONS

This application claims priority of U.S. Provisional Application No. 61/035,530 filed on Mar. 11, 2008. The contents of this application are incorporated herein by reference in their entirety.

### BACKGROUND OF THE INVENTION

1. Field of the Invention

The present invention relates to a slot machine and a playing method thereof, which allow players to enjoy slot games with the use of gaming media such as coins or bills.

2. Description of the Related Art

In a conventional slot machine, if a player inserts gaming media such as coins or bills into an insertion slot and presses a spin button, a plurality of symbols are then displayed in a scrolling manner on a display device provided on the front surface of a casing, and thereafter, scrolling of the respective symbols is automatically stopped.

In such a slot machine, if a predetermined combination of symbols is displayed in a stopped state along a payline, a predetermined number of gaming media are then paid out, as disclosed in, for example, U.S. Pat. No. 6,604,999-B2 and US 2002-065124-A1. Regardless of the payline, further, a predetermined number of gaming media are paid out, corresponding to the number of specific symbols referred to as scatter symbols, which were displayed on the display device.

The present invention provides a slot machine and a playing method thereof, which can offer entertainability to players that has not been successfully attained by those of the aforementioned conventional art.

### SUMMARY OF THE INVENTION

A first aspect of the present invention is a slot machine, comprising:
a display device on which plural types of symbols are arranged;
at least one memory; and
a controller,
the controller being configured to:
   (i) store at least one item of predetermined numeric range information in the memory;
   (ii) randomly determine a specific numeric value from among the predetermined numeric range information stored in the memory and store the determined specific numeric value in the memory;
   (iii) automatically rearrange the plural types of symbols arranged on the display device;
   (iv) judge whether a state of rearrangement of predetermined symbols is established on the symbol-rearranged display device;
   (v) count one state of rearrangement of the predetermined symbols as one count and store the counted number of times in the memory in a case where it is judged that the state of rearrangement of the predetermined symbols is established, as a result of the judgment in the itemized (iv); and
   (vi) award prizes having predetermined values in a case where the number of times in establishing the state of rearrangement of the predetermined symbols stored in the itemized (v), reaches the specific numeric value stored in the itemized (ii), as a result of repeating processing in the itemized (iii) to (v).

According to the first aspect of the present invention, at least one item of predetermined numeric range information is stored in a memory. Then, a specific numeric value is randomly determined from among the predetermined numeric range information stored in the memory, and the determined specific numeric value is stored in the memory. Further, plural types of symbols arranged on the display device are automatically rearranged, and it is judged whether or not a state of rearrangement of predetermined symbols is established on the symbol-rearranged display device. As a result of the judgment, in a case where it is judged that the state of rearrangement of the predetermined symbols is established, the judged state is counted as one count and the counted number of times is stored in the memory. Furthermore, in a case where the number of times in establishing the stored state of rearrangement of the predetermined symbols reached the stored specific numeric value, prizes having predetermined values are awarded. In this manner, the prizes are awarded in a case where the specific number of times in winning BONUS, so that a player can continuously enjoy the play of games for the specific number of times in winning BONUS. Moreover, the specific number of times in winning BONUS is randomly determined, so that a variety of winning prizes in number can be provided.

A second aspect of the present invention the controller, in the itemized (v), counts the state of rearrangement of the predetermined symbols as one count in a case where it is judged that the state of rearrangement of the predetermined symbols is established; causes the memory to store the counted number; and causes the display device to display the stored number of times in establishing the states of rearrangement of the predetermined symbols.

According to the second aspect of the present invention, in a case where it is judged that the state of rearrangement of the predetermined symbols is established, as a result of the judgment, the judged state is counted as one count and the counted number of times is stored in the memory. Then, the number of times in establishing the stored state of rearrangement of the predetermined symbols is displayed on the display device. In this manner, a current total number of times in winning BONUS is displayed, thus allowing the player to keep track of the current total number of times in winning BONUS and to sustain the feeling of excitement that the prizes are awarded.

A third aspect of the present invention is a slot machine constituted as set forth below. In the first aspect, the controller causes the display device to display the predetermined numeric range information stored in the memory in the itemized (i).

According to the third aspect of the present invention, the predetermined numeric range information stored in the memory is displayed on the display device. In this manner, the range of the number of times in winning BONUS is displayed, thus allowing the player to keep track of the range of the number of times in winning BONUS until the prizes are awarded and to sustain the feeling of excitement that the prizes are awarded.

A fourth aspect of the present invention is a slot machine constituted as set forth below. In the first aspect, the controller, in the itemized (iv), further includes processing of causing the display device to display information concerning the specific numeric value in a case where the number of times in establishing the state of rearrangement of the predetermined symbols, stored in the itemized (v), reaches the specific numeric value stored in the itemized (ii) as a result of repeating processing in the itemized (iii) to (v).

According to the fourth aspect, the slot machine further includes processing of, in a case where the stored number of times in establishing the state of rearrangement of the predetermined symbols reached the stored specific numeric value, as a result of repeating games, causing the display device to display information concerning the specific numeric value. In this manner, the fact that the current total number of times in winning BONUS is the specific number of times in winning BONUS is displayed, thus allowing the player to keep track of the randomly determined specific number of times in winning BONUS.

A fifth aspect of the present invention is a slot machine constituted as set forth below. In the first aspect, the slot machine further includes an input device for inputting a BET and, when the BET is input from the input device on a one-by-one game basis, the controller counts the input BET, causes the memory to store the counted BET number, and then, adds the stored BET number to predetermined values of the prizes in the itemized (vi).

According to the fifth aspect of the present invention, if the BET is input from the input device on a one-by-one game basis, the input BET is counted, and then, the counted BET number is stored in the memory. Then, the stored BET number is added to the predetermined values of prizes. In this manner, the values of the prizes are accumulated by a plurality of games, thus resulting in high payment. Thus, the player can enhance the feeling of expectation on a game-by-game basis.

A sixth aspect of the present invention is a slot machine constituted as set forth below. In the first aspect, the controller causes the memory to store a plurality of predetermined numeric range information; randomly determines one item of predetermined numeric range information from among the plurality of the stored predetermined numeric range information; randomly determines a specific numeric value from among the determined predetermined numeric range information; and causes the memory to store the determined specific numeric value.

According to the sixth aspect of the present invention, a plurality of predetermined numeric range information are stored in the memory, and then, one item of the predetermined numeric range information is randomly determined from among the plurality of the stored predetermined numeric range information. Then, a specific numeric value is randomly determined from the determined predetermined numeric range information, and then, the determined specific numeric value is stored in the memory. In this manner, a specific number of times in winning BONUS, according to the plurality of winning prize range information, is determined, thus making it possible to provide to the player a variety of specific numbers of times in winning prizes.

A seventh aspect of the present invention is a slot machine constituted as set forth below. In the first aspect, the controller, in the itemized (v), further includes processing of giving a payment based upon the state of rearrangement of the predetermined symbols, in a case where it is judged that the state of rearrangement of the predetermined symbols is established as a result of the judgment in the itemized (iv).

According to the seventh aspect of the invention, the slot machine further includes processing of, in a case where it is judged that the state of rearrangement of the predetermined symbols is established, as a result of the judgment of (iv), giving a payment based upon the state of rearrangement of the predetermined symbols. In this manner, the number of times in winning BONUS is counted and the payment based upon the winning prize is given, thus making it possible to provide the winning prize-based payment to the player.

An eighth aspect of the present invention is a slot machine constituted as set forth below. In the first aspect, the prizes, in the itemized (v), include a first prize and a second prize; and the controller, in the itemized (vi), awards either of the first prize and the second prize by internal lottery in a case where the number of times in establishing a state of rearrangement of the predetermined symbols, which are stored in the itemized (v), reaches the specific numeric value stored in the itemized (ii) as a result of repeating processing in the itemized (iii) to (v).

According to the eighth aspect, the prizes include the first and second prizes that are different from each other in value of payment. In a case where the stored number of times in establishing the state in which predetermined symbols are arranged reached the stored specific numeric value, as a result of repeating games, either of the first and second prizes is awarded by internal lottery. In this manner, a variety of prizes can be provided.

A ninth aspect of the present invention is a slot machine constituted as set forth below. In the first aspect, the state of rearrangement of the predetermined symbols is a state in which a combination of the predetermined symbols or a predetermined number of predetermined symbols is rearranged.

According to the ninth aspect of the present invention, the state of rearrangement of the predetermined symbols is a state in which a combination of the predetermined symbols is realized or a predetermined number of predetermined symbols is arranged. In this manner, a variety of states of rearrangement of symbols can be provided.

A tenth aspect of the present invention is a slot machine constituted as set forth below. In the first aspect, the controller initializes the specific numeric value stored in the memory in the itemized (ii) in a case where processing in the itemized (iii) is not repeatedly performed, based upon a player's instruction, after processing in the itemized (v).

According to the tenth aspect of the present invention, after the end of one game, in a case where repetition game start processing is not performed, based upon the player's instruction, the specific numeric value stored in the memory is initialized. In this manner, the specific numeric value is automatically initialized, thus making it possible to provide a fair-state game to a next player.

An eleventh aspect of the present invention is a slot machine constituted as set forth below. In the first aspect, the slot machine includes a reset input device for initializing the specific numeric value stored in the processing in the itemized (ii), and the controller initializes the specific numeric value stored in the memory in the itemized (ii) in a case where a player performs input from the reset input device.

According to the eleventh aspect of the present invention, in a case where the player performs input from the reset input device, the specific numeric value stored in the memory is initialized. In this manner, the specific numeric value can be initialized based on the player's will.

A twelfth aspect of the present invention is a slot machine, comprising:
a display device on which plural types of symbols are arranged and a specific effect display is established;
at least one memory; and
a controller,
the controller being configured to:
   (i) store at least one item of predetermined numeric range information in the memory;
   (ii) randomly determine a specific numeric value from among the predetermined numeric range information stored in the memory and store the determined specific numeric value in the memory;
   (iii) automatically rearrange the plural types of symbols arranged on the display device;
   (iv) judge whether a state of rearrangement of predetermined symbols is established on the symbol-rearranged display device;
   (v) give a predetermined payment in a case where it is judged that the state of rearrangement of the predetermined symbols is established, as a result of the judgment in the itemized (iv);
   (vi) count the number of times in establishing the specific effect display and store the counted number of times in the memory in a case where the specific effect display is established on the display device, in at least one of processing operations in the itemized (iii) to (v); and
   (vii) award prizes having predetermined values in a case where the number of times in establishing the specific display stored in the itemized (vi) reaches the specific numeric value stored in the itemized (ii), as a result of repeating processing operations in the itemized (iii) to (vi).

According to the twelfth aspect of the present invention, at least one item of predetermined numeric range information is stored in the memory. A specific numeric value is randomly determined from among the predetermined numeric range information stored in the memory and the determined specific numeric value is stored in the memory. The plural types of symbols arranged on the display device are automatically rearranged and it is judged whether or not a state of rearrangement of predetermined symbols is established on the rearranged-symbol display device. In a case where a specific effect display is established on the display device in a game, the number of times in establishing the specific effect display is counted and the counted number is stored in the memory. In a case where the specific effect display is established on the display device, in the game, the number of times in establishing the specific effect display is counted and the counted number of times is stored in the memory. In a case where the number of times in establishing the stored specific display reaches the stored specific numeric value, as a result of repeating games, the prizes having predetermined values are awarded. The player can continuously enjoy the play of games for the specific number of times in establishing effect display. Further, the specific number of times in establishing effect display is randomly determined, thus making it possible to provide a variety of effect displays in number.

A thirteenth aspect of the present invention is a slot machine constituted as set forth below. In the twelfth aspect, the controller, in the itemized (iv), counts the number of times in establishing the specific effect display in a case where the specific effect display is established on the display device in at least one of processing operations in the itemized (iii) to (v); causes the memory to store the counted number of times; and causes the display device to display the stored number of times in establishing the specific effect display.

According to the thirteenth aspect of the present invention, in a case where the specific effect display is established on the display device in a game, the number of times in establishing the specific effect display is counted and the counted number of times is stored in the memory. Then, the stored number of times in establishing the specific effect display is displayed on the display device. In this manner, a current total number of effects is displayed, thus allowing the player to keep track of the current total number of effects and sustain the feeling of expectation that the prizes are awarded.

A fourteenth aspect of the present invention is a slot machine constituted as set forth below. In the twelfth aspect, the controller causes the display device to display the predetermined numeric range information stored in the memory.

According to the fourteenth aspect of the present invention, the predetermined numeric range information stored in the memory is displayed on the display device. In this manner, the range of the number of times in establishing effect display is displayed, thus allowing the player to keep track of the number of times in establishing effect display until prizes are awarded to the player and to sustain the feeling of expectation that prizes are awarded.

A fifteenth aspect of the present invention is a slot machine constituted as set forth below. In the twelfth aspect, the controller, in the itemized (vii), further includes processing of causing the display device to display information concerning the specific numeric value in a case where the number of times in establishing the specific effect display, stored in the itemized (vi), reaches the specific numeric value stored in the itemized (ii), as a result of repeating processing operations in the itemized (iii) to (vi).

According to the fifteenth aspect of the present invention, the slot machine further includes processing of causing he display device to display information concerning the specific numeric value in a case where the stored number of times in establishing the specific effect display reaches the stored specific numeric value, as a result of repeating games. In this manner, the fact that the current total number of times in establishing effect display is the specific number of times in establishing effect display is displayed, thus allowing the player to keep track of the randomly determined specific number of times in establishing effect display.

A sixteenth aspect of the present invention is a slot machine playing method, comprising the steps of:
(i) storing at least one item of predetermined numeric range information in the memory;
(ii) randomly determining a specific numeric value from among the predetermined numeric range information stored in the memory and storing the determined specific numeric value in the memory;
(iii) automatically rearranging the plural types of symbols arranged on the display device;
(iv) judging whether or not a state of rearrangement of predetermined symbols is established on the symbol-rearranged display device;
(v) counting the state of rearrangement of the predetermined symbols as one count and storing the counted number of times in the memory in a case where it is judged that the state of rearrangement of the predetermined symbols is established as a result of the judgment in the step (iv); and
(vi) awarding prizes having predetermined values in a case where the number of times in establishing the state of rearrangement of the predetermined symbols, which is stored in the step (v), reaches the specific numeric value stored at the step (ii), as a result of repeating the steps (iii) to (v).

According to the sixteenth aspect of the present invention, at least one item of predetermined numeric range information is stored in the memory. A specific numeric value is randomly determined from among the predetermined numeric range information stored in the memory and the determined specific numeric value is stored in the memory. Then, the plural types of symbols arranged on the display device are automatically rearranged. It is judged whether or not a state of rearrangement of predetermined symbols is established on the symbol-rearranged display device. In a case where it is judged that the state of rearrangement of the predetermined symbols is established as a result of the above judgment, the state of rearrangement of the predetermined symbols is counted as one count and the counted number of symbols is stored in the memory. Further, in a case where the number of times in establishing the stored state of rearrangement of the predetermined symbols reaches the stored specific numeric value, as a result of repeating games, prizes having predetermined values are awarded. In this manner, the prizes are awarded in a case where the specific number of times in winning BONUS is reached, thus allowing the player to continuously enjoy the play of games for the specific number of times in winning BONUS. Furthermore, the specific number of times in winning BONUS is randomly determined, thus making it possible to provide a variety of winning prizes in number.

A seventeenth aspect of the present invention is a slot machine playing method constituted as set forth below. In the sixteenth aspect, in a case where it is judged that the state of rearrangement of the predetermined symbols is established as a result of the judgment at the step (v), the state of rearrangement of the predetermined symbols is counted on a one-by-one game basis and the counted number of times is stored in the memory, and then, the stored number of times in establishing the state of rearrangement of the predetermined symbols is displayed on the display device.

According to the seventeenth aspect of the present invention, in a case where it is judged that the state of rearrangement of the predetermined symbols is established as a result of the above judgment, the state of rearrangement of the predetermined symbols is counted on a one-by-one game basis; the counted number of times is stored in the memory; and the stored number of times in establishing the state of rearrangement of the predetermined symbols is displayed on the display device. In this manner, the current total number of times in winning BONUS is displayed, thus allowing the player to keep track of the current total number of times in winning BONUS and sustain the feeling of expectation that the prizes are awarded.

An eighteenth aspect of the present invention is a slot machine playing method constituted as set forth below. In the sixteenth aspect, the playing method further includes the step of causing the display device to display the predetermined numeric range information stored in the memory in the step (i).

According to the eighteenth aspect of the present invention, the predetermined numeric range information stored in the memory is displayed on the display device. In this manner, the range of the number of times in winning BONUS is displayed, thus allowing the player to keep track of the range of the number of times in winning BONUS until prizes are awarded and sustain the feeling of expectation that the prizes are awarded.

A nineteenth aspect of the present invention is a slot machine playing method constituted as set forth below. In the sixteenth aspect, the playing method further includes the step of, in the step (vi), in a case where the number of times in establishing the state of rearrangement of the predetermined symbols, which is stored at the step (v), reaches the specific numeric value stored at the step (ii), as a result of repeating the steps (iii) to (v), causing the display device to display information concerning the specific numeric value.

According to the nineteenth aspect of the present invention, the playing method further includes the step of, in a case where the number of times in establishing the state of rearrangement of the predetermined symbols reaches the stored specific numeric value, as a result of repeating games, causing the display device to display information concerning the specific numeric value. In this manner, the fact that the current total number of times in winning BONUS is the specific number of times in winning BONUS is displayed, thus allowing the player to keep track of the specific number of times in winning BONUS, which were internally randomly determined.

A twentieth aspect of the present invention is a slot machine playing method constituted as set forth below. In the sixteenth aspect, the playing method further includes the step of, when a BET number is input from an input device one a one-by-one game basis, counting the input BET number, causing the memory to store the counted BET number, and adding the stored BET number to the predetermined values of the prizes.

According to the twentieth aspect of the present invention, when a BET number is input from an input device one a one-by-one game basis, the input BET number is counted, and then, the counted BET number is stored in the memory. The stored BET number is added to the predetermined values of the prizes. Thus, it is possible for the player to increase the feeling of expectation on a game-by-game basis.

According to the present invention, a slot machine and a playing method thereof, having added new entertainability, can be provided because prizes having predetermined values are awarded in a case where the specific number of times in winning BONUS, which was randomly determined, is reached.

### BRIEF DESCRIPTION OF THE DRAWINGS

FIG. 1 is a flowchart showing a subroutine of game execution processing;

FIG. 2 is a view for explaining a table for determining the number of times in winning BONUS;

FIG. 3A is a view showing an exemplary display of symbols arranged in a display device;

FIG. 3B is a view showing an exemplary display of symbols arranged in the display device;

FIG. 4 is a view for explaining a BONUS lottery table;

FIG. 5 is a perspective view showing an appearance of a slot machine;

FIG. 6 is a view for explaining a symbol arrangement table;

FIG. 7 is a view for explaining a scatter prize;

FIG. 8 is a block diagram depicting an internal configuration of the slot machine;

FIG. 9 is a flowchart showing a subroutine of main processing;

FIG. 10 is a flowchart showing a subroutine of game execution processing, which is identical to that of in FIG. 1;

FIG. 11A is a view showing an exemplary display of symbols arranged on the display device;

FIG. 11B is a view showing an exemplary display of symbols arranged on the display device;

FIG. 11C is a view showing an exemplary display of symbols arranged on the display device;

FIG. 11D is a view showing an exemplary display of symbols arranged on the display device;

FIG. 11E is a view showing an exemplary display of symbols arranged on the display device;

FIG. 12 is a flowchart showing a subroutine of symbol determination processing; and

FIG. 13 is a flowchart showing a subroutine of future game processing.

### DESCRIPTION OF THE PREFERRED EMBODIMENTS

Hereinafter, one embodiment of a slot machine and a playing method thereof, according to the present invention, will be described with referring to the drawings.

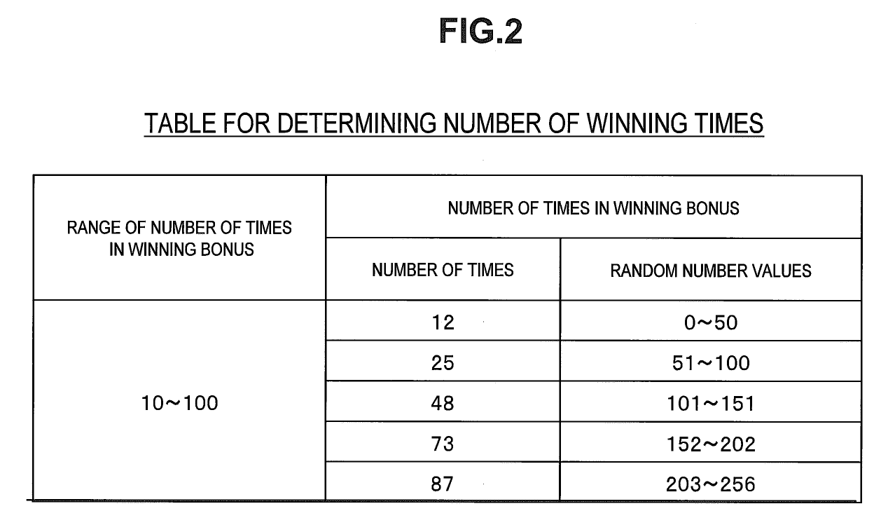

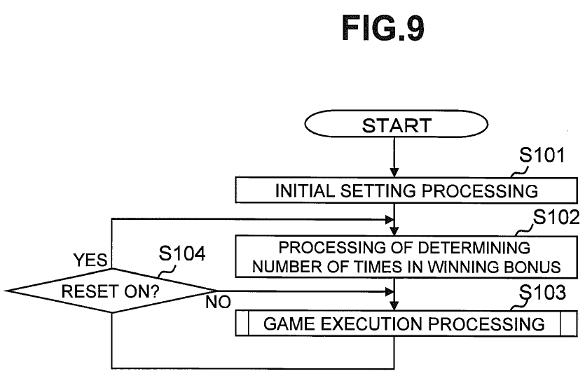

Referring to the table in FIG. 2, the table for determining the number of times in winning BONUS, which was stored in a ROM42, a main CPU41 included in a slot machine 10 according to the embodiment randomly determines a specific number of times in winning BONUS (12, 25, 48, 73, and 87) from among items of information concerning a range of the number of times in winning BONUS (10 to 100). Then, this CPU causes the RAM43 to store the determined specific number of times in winning BONUS (for example, 12) and the items of information concerning a range of the number of times in winning BONUS (10 to 100) (see step S102 of FIG. 9).

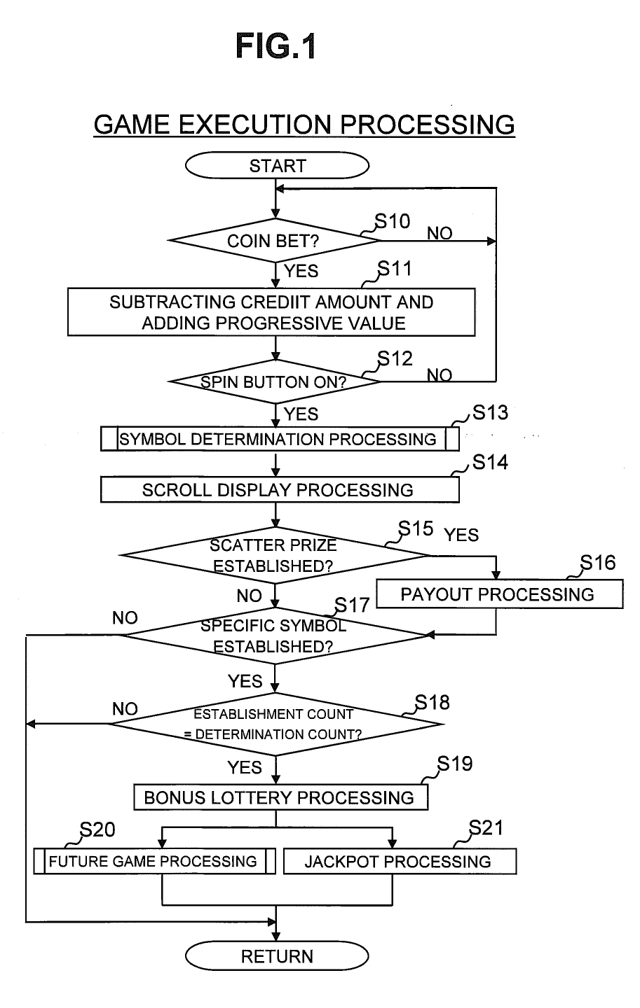

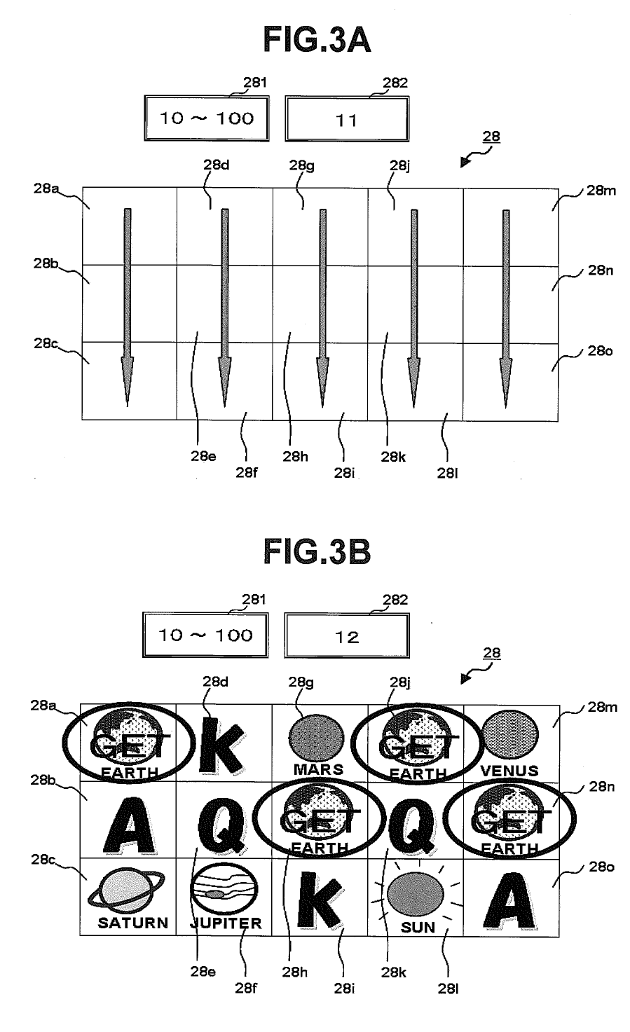

The main CPU41, as shown in FIG. 1, automatically rearranges plural types of symbols arranged in display blocks 28 of a lower image display panel 16 (step S14) (see FIG. 3A). Then, the main CPU41 judges whether three or more BONUS trigger symbols are displayed in a stopped state in any of the display blocks 28 for displaying the rearranged symbols and whether or not a condition for winning BONUS is established (step S17) (see FIG. 3B).

In a case where it is judged that a condition for winning BONUS is established as the result of judgment at step S17 (S17: YES), the main CPU41 counts the number of times in winning BONUS as one count and causes the RAM43 to store the counted number.

As the result of repeating games (steps S10 to S17), after the number of times in winning BONUS stored in the RAM43 is randomly determined at step S102, in a case where the determined number reaches a specific number of times in winning BONUS (for example, 12) stored in the RAM43 (step S18), the main CPU41 establishes “BONUS IN”.

Upon the establishment of “BONUS IN”, the main CPU41 executes BONUS lottery processing (step S19), and then, determines the transition to a future game or the payout of a progressive jackpot, with referring to the BONUS lottery table. When either of them is determined, the corresponding prize is awarded to a player. In the future game processing at step S20 or in the payout processing of the progressive jackpot at step S21, processing of resetting a specific number of times in winning BONUS is performed. When this resetting processing is performed, the main CPU41 randomly executes processing of determining the specific number of times in winning BONUS (S104 of FIG. 9), followed by repeatedly executing the aforementioned processing shown in FIG. 1.

The main CPU41 displays items of information (10 to 100) concerning a range of the number of times in winning BONUS, which were stored in the RAM43 in games, and a current number of times in winning BONUS, at a win-count range portion 281 and a win-count display portion 282 (see FIGS. 3A and 3B).

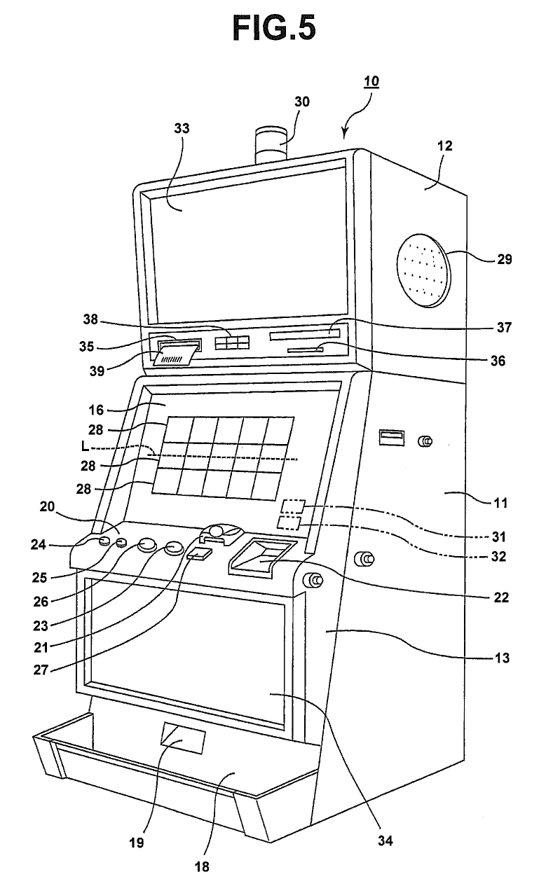

Next, a configuration of the slot machine 10 will be described with referring to FIG. 5. The slot machine 10 of the present embodiment is a video type slot machine, whereas the present invention is applicable to a slot machine of a mechanical reel type. Further, the slot machine 10 is a standalone type, which is not connected to a network, whereas the present invention is applicable to a networked slot machine.

In the slot machine 10, coins, bills or electronic valid information equivalent thereto are employed as gaming media. In the present invention, however, the gaming media are not limitative thereto in particular, and can include medals, tokens, electric money, and tickets, for example. The above tickets are not limitative thereto in particular, and can include bar code-attached tickets or the like, as described later, for example.

The slot machine 10 is provided with: a cabinet 11; a top box 12 installed at the upper side of the cabinet 11; and a main door 13 provided at the front face of the cabinet 11.

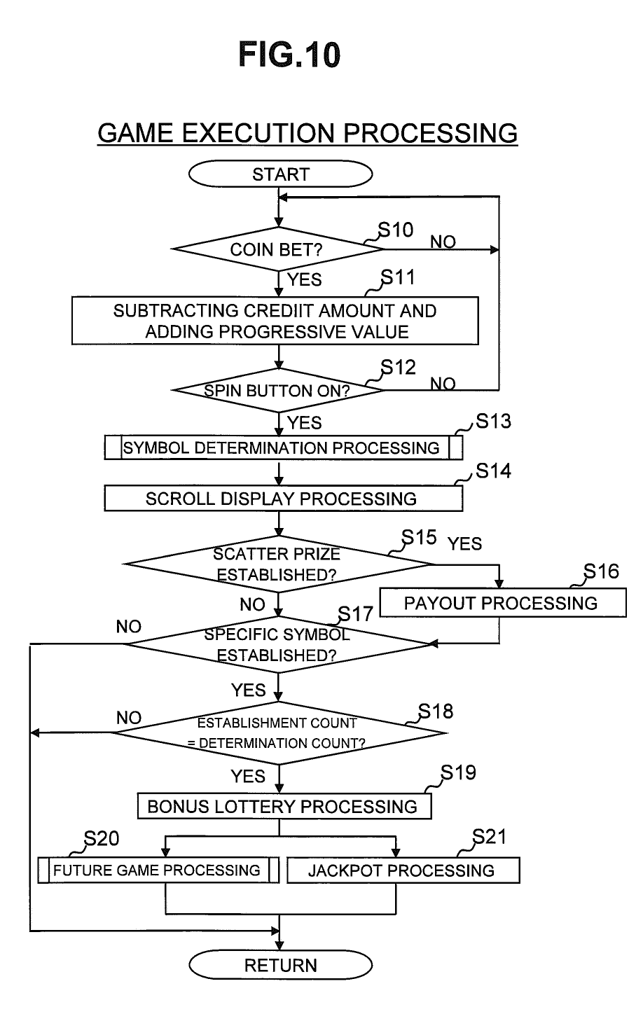

The lower image display panel 16 serving as a display device is provided in front of the main door 13. The lower image display panel 16 is provided with a liquid crystal panel, which displays the cells of the symbol matrix 28(28a to 28o) in three rows and five columns. A single symbol is displayed in each of the display block 28. Further, the lower image display panel 16 includes: the win-count range display portion 281; and the win-count display portion 282 (see FIG. 10A). The lower image display panel 16 is equivalent to a display device according to the present invention.

In addition, a credit amount display portion 31 and a payout number display portion 32 are set on the lower image display panel 16. At the credit amount display portion 31, the number of credited coins is displayed by way of image. At the payout display portion 32, the number of coins paid out in a case where symbols of the same type are displayed in a stopped state by a predetermined number or more in the display blocks 28, is displayed by way of image.

Further, on the front face of the lower image display panel 16, a touch panel 69 is provided, although not shown, so that a player can enter various instructions by operating the touch panel 69.

Provided downwardly of the lower image display panel 16 are: a control panel 20 made of a plurality of buttons 23 to 27 for a player to input instructions associated with the progress of a game; a coin insertion slot for accepting coins in the cabinet 11; and a bill validator 22.

On the control panel 20, a SPIN button 23, a CHANGE button 24, a CASHOUT button 25, a 1-BET button 26, and a MAX-BET button 27 are provided. The SPIN button 23 is intended to enter an instruction for starting scroll-display of symbols. The CHANGE button 24 is employed when a player requests the attendant in game facility to change money. The CASHOUT button 25 is intended to enter an instruction for paying out credited coins to a coin tray 18.

The 1-BET button 26 is intended to enter an instruction for betting one coin on a game from among the credited coins. The MAX-BET button 27 is intended to enter an instruction for betting the maximum number of coins (50 coins in the present embodiment) that can be betted in one game. The 1-BET button 26 and the MAX-BET button 27 are equivalent to an input device according to the present invention.

The insertion of gaming media denotes that gaming media are betted on games. For example, in a case where the coins inserted into the coin insertion slot 21 are directly betted on games, coin insertion into the coin insertion slot 21 is equivalent to insertion of gaming media. Specifically, if coins are inserted into the coin insertion slot 21, they are temporarily credited. When the 1-BET button 26 and the MAX-BET button 27 are operated, the credited coins are betted on games. In this case, the fact that the credited coins are betted on games is equivalent to insertion of gaming media.

The bill validator 22 validates whether or not bills are valid and accepts valid bills in the cabinet 11. The bill validator 22 may be constructed so that bar code-attached tickets 39 described later are readable thereby. Provided on the lower front face of the main door 13, i.e., downwardly of the control panel 20 is a belly glass 34 on which a character or the like of the slot machine 10 was expressed.

An upper image display panel 33 is provided on the front face of the top box 12. The upper image display panel 33 is provided with a liquid crystal display panel, and displays images representative of an introduction to the contents of a game or explanation of game rules. In addition, the upper image display panel 33 displays effect images when a future game or a progressive jackpot is established as a special prize.

In addition, a speaker 29 is provided at the top box 12. At the lower side of the upper image display panel 33, a ticket printer 35, a card reader 36, a data display 37, and a keypad 38 are provided. The ticket printer 35 prints, on tickets, bar codes having coded therein a variety of data including credit number, date and time, and identification number of slot machine 10. The printed tickets are output as bar code-attached tickets 39. A player causes another slot machine to read the bar code-attached tickets 39, allowing the slot machine to perform games, or alternatively, allowing the exchange of bar code-attached tickets 39 with bills or the like at a predetermined site of a game facility (for example, at the casher in a casino).

The card reader 36 is intended to read and write data from/into a smart card. The smart card is a player-owned card, and stores data for recognizing the player and data concerning the log of games that were performed by the player. The smart card may store data equivalent to coins, bills, or credits. In addition, a magnetic stripe card may be employed in place of the smart card. A data display 37 is made up of a fluorescent display or the like, and displays the data read by the card reader 36 and the data input by the player via the keypad 38, for example. The keypad 38 is intended to input the instructions and data concerning the issuance of tickets or the like.

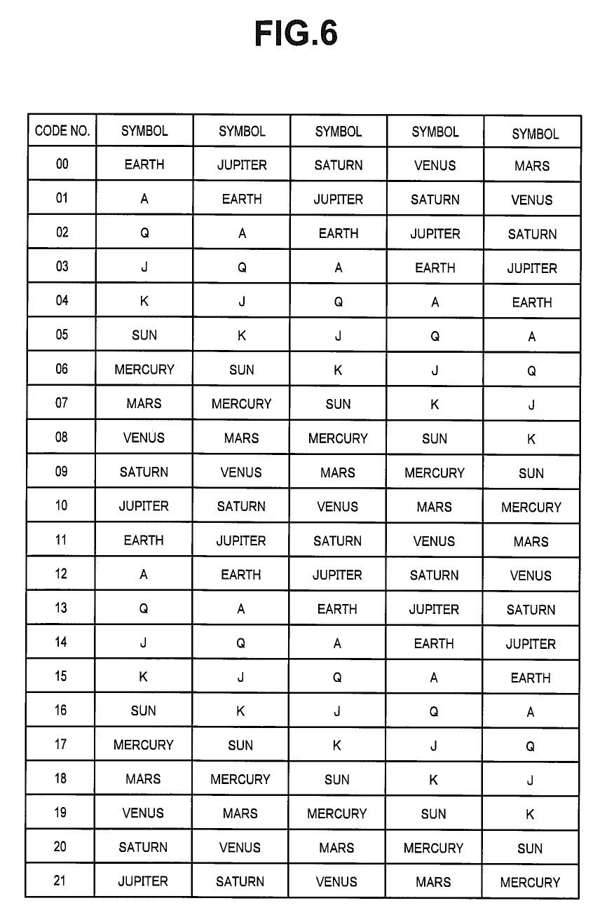

FIG. 6 is a view for explaining a symbol arrangement table. As shown in FIG. 6, each column of a total of 22 symbols made up of code Nos. 00 to 21 is displayed in a scrolled manner in each of the display blocks 28. Such each column of the symbols is constituted so that symbols “EARTH”, “JUPITER”, “SATURN”, “SUN”, “VENUS”, “MARS”, “MERCURY”, “K”, “J”, “Q”, and “A” are arranged in combination. These symbols are all scatter symbols.

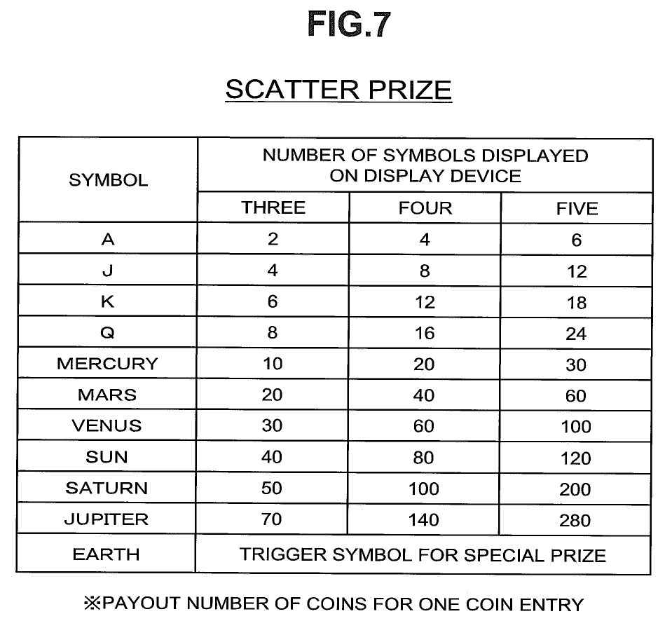

FIG. 7 is a view for explaining a scatter prize. Symbols “JUPITER”, “SATURN”, “SUN”, “VENUS”, “MARS”, “MERCURY”, “K”, “J”, “Q”, and “A” are trigger symbols for the scatter prize. In a case where three or more of these symbols are displayed (rearranged) in a stopped state in any of the display blocks 28 of the lower display panel 16, a predetermined number of coins are paid out as the scatter prize in accordance with the types and number of symbols and the BET number, based upon FIG. 7. As shown in the figure, for example, in a case where three or more of these symbols are displayed (rearranged) in a stopped state in any of the display blocks 28 of the lower image display panel 16, a predetermined number of coins are paid out as a scatter prize in accordance with the types and number of symbols and the BET number, based upon FIG. 7. As shown in FIG. 7, for example, if three “JUPITER” symbols are displayed in stopped state in any of the display blocks 28, 70 coins are paid out; if four “JUPITER” symbols are displayed, 140 coins are paid out; and if five “JUPITER” symbols are displayed, 280 coins are paid out (the number of coins is calculated for one coin entry).

Hereinafter, a description of the symbol “EARTH” will be furnished. “EARTH” is a trigger symbol for BONUS. In a case where three or more of the “EARTH” symbols are displayed (rearranged) in a stopped state in any of the display blocks 28, a winning BONUS prize is established. If the winning BONUS is established on a game-by-game basis, the number of winning BONUS prizes is counted, and then, the counted numeric values are stored in the RAM43. As the result of repeating games, in a case where the counted number of times in winning BONUS reached a special number of times in winning BONUS stored in the RAM43 (for example, 12), “BONUS IN” is established, and then, predetermined BONUS is awarded to a player. The number of times in winning BONUS is read from the RAM43, and then, the reading is displayed on the win-count display portion 282, of the lower image display panel 16.

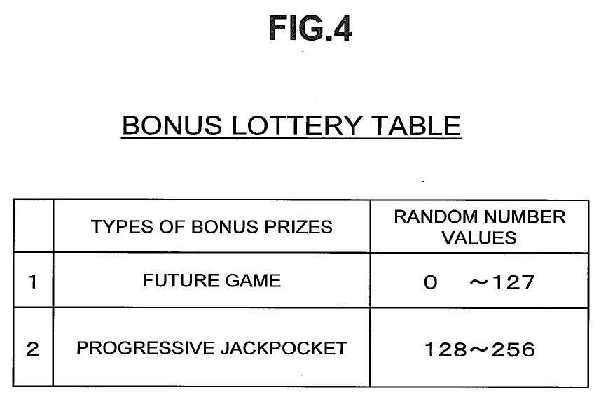

If the aforementioned “BONUS IN” is established, a BONUS lottery is performed. In this BONUS lottery, with referring to the BONUS lottery table shown in FIG. 4, which was stored in the ROM42, a predetermined random number value is selected from among a plurality of random number values, whereby the transition to a future game or the payout of a progressive jackpot is randomly determined.

In the future game, a player executes a free game, the number of which was determined based upon the random number values obtained by executing a random number generation program included in symbol determination programs. This free game can be played without betting coins. As to the progressive jackpot, the payout of a large number of coins, based upon a progressive value, is executed. The progressive value is obtained by accumulatively adding the BET number from a BET button 26 or 27 input on the game-by-game basis. The future game is equivalent to a first prize according to the present invention and the progressive jackpot is equivalent to a second prize according to the present invention.

A game outline will be described hereinafter. When a game is started, a specific number of times in winning BONUS (12, 25, 48, 73, or 87) is randomly determined from among items of information concerning the range of the number of times in winning BONUS, with referring to a table for determining the number of times in winning BONUS, shown in FIG. 2, which was stored in the ROM42. In addition, the determined specific number of times in winning BONUS (for example, 12) and the items of information concerning the range of the number of times in winning BONUS (10 to 100), are stored in the RAM43. Then, plural types of symbols stored in display blocks 28 of the lower image display panel 16 are automatically rearranged. Further, it is judged whether three or more trigger symbols for the scatter prize are displayed in a stopped state in any of the rearranged display blocks 28 or whether three or more BONUS trigger symbols are displayed in a stopped state, and then, winning BONUS is established. In a case where it is judged that the scatter prize is established as the result of the above judgment, a predetermined number of coins are paid out according to the number of displayed symbols. Further, in a case where it is judged that winning BONUS is established as the result of the above judgment, winning BONUS is counted as one count and the counted number of times is stored in the RAM43. In a case where the number of times in winning BONUS stored in the RAM43 reached the specific number of times in winning BONUS (for example, 12) randomly determined and stored in the RAM43 as the result of repeating games, “BONUS IN” is established. When “BONUS IN” is established, BONUS lottery processing is executed, and then, the transition to a future game or the payout of a progressive jackpot is determined. If either of them is determined, the corresponding prize is awarded to a player.

The range (10 to 100) of the number of times in winning BONUS, which was stored in the RAM43 in games, and a current total number of times in winning BONUS are displayed at the win-count range display portion 281 and the win-count display portion 282.

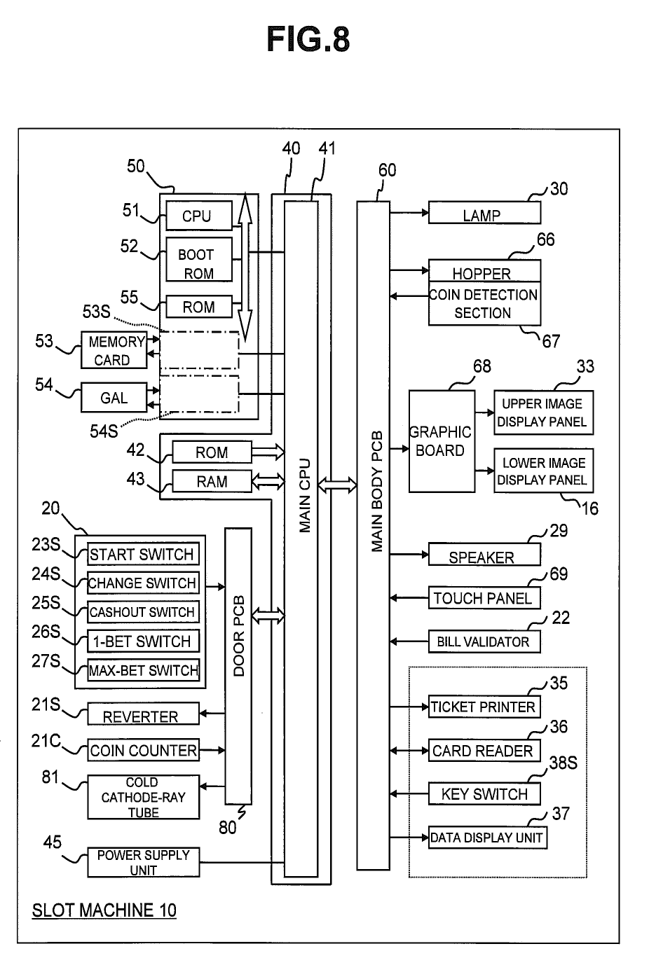

FIG. 8 is a block diagram depicting an internal configuration of a slot machine. A gaming board 50 is provided with: a CPU (Central Processing Unit) 51, a ROM55, and a boot ROM52, which were interconnected via an internal bus; a card slot 53S compatible with a memory card 53; and an IC socket 54S compatible with a GAL (Generic Array Logic) 54.

The memory card 53 is made up of non-volatile memories such as CompactFlash (registered trademark), and stores game programs. The game programs contain a symbol determination program. The symbol determination program is intended for determining symbols (code Nos. corresponding to the symbols) which are displayed in a stopped state along the payline L.

The card slot 53S is constituted such that the memory card 53 can be inserted into or drawn out from, and is connected to a motherboard 40 through an IDE bus 40. Therefore, the types or contents of games played in the slot machine 10 can be changed by removing the memory card 53 from the card slot 53S, writing different game programs into the memory card 53, followed by inserting the memory card 53 into the card slot 53S. The game programs include those related to the progress of a game. The game programs further include: image data and sound data output at the time of the play of a game.

The CPU51, the ROM55, and the boot ROM52 interconnected via the internal bus are connected to the motherboard 40 via a PCI bus. The PCI bus not only performs signal transmission between the motherboard 40 and the gaming board 50, but also supplies power from the motherboard 40 to the gaming board 50.

The motherboard 40 is constructed with a commercially available general-purpose motherboard (a printed circuit board on which the essential parts of a personal computer are mounted). This motherboard includes: a main CPU41; a ROM (Read Only Memory) 42; a RAM (Random Access Memory) 43; and a communication interface (not shown). The main CPU41 functions as the controller of the present invention. Further, the RAM43 is equivalent to the memory according to the present invention.

The ROM42 is made up of a memory device such as a flash memory, and stores a program such as a BIOS (Basic Input/Output System) executed by the main CPU41 and permanent data. When the main CPU41 executes the BIOS, initialization processing is performed for predetermined peripheral devices, and capture processing of the game program stored on the memory card 53 is also started via the gaming board 50. In the present invention, the contents of the ROM42 may be rewritable or not. In the present embodiment, the ROM42 stores: the table for determining the number of times in winning BONUS, shown in FIG. 2; the BONUS lottery table shown in FIG. 4; the symbol arrangement table shown in FIG. 6; and the scatter-prize payment table shown in FIG. 7, for example. In the table for determining the number of times in winning BONUS, shown in FIG. 2, the range of the number of times in winning BONUS is between 10 and 100. The specific number of times (12, 25, 48, 73, or 87) is set to be randomly determined from among the range (10 to 100) of the number of times in winning BONUS. The specific number of times in winning BONUS is determined by selecting a specific random number value from among a plurality of random number values.

The RAM43 stores data and programs employed when the main CPU41 is activated. In addition, the RAM43 can store game programs. Further, the RAM43 stores data such as BET number input from the BET button; the number of symbols arranged on an activated payline or the number of symbols arranged in each of the display blocks 28; credit amount; and coin entry number or payout number in one game.

Both a body PCB (Printed Circuit Board) 60 and a door PCB80, which will be described later, are connected to the motherboard 40 by the USB. A power supply unit 45 is also connected to the motherboard 40.

Equipment and devices, which generate input signals to be input to the main CPU41, and equipment and devices, operations of which are controlled by a control signal output from the main CPU41, are connected to the body PCB60 and the door PCB80. The main CPU41 executes the game programs stored in RAM 43, based upon an input signal that was input to the main CPU41, thereby performing predetermined computational processing. Then, this CPU41 stores results thereof into RAM43; and transmits control signals to equipment and devices as control processing relative to the equipment and devices.

A lamp 30, a hopper 66, a coin detecting section 67, a graphic board 68, a speaker 29, a touch panel 69, a bill validator 22, a ticket printer 35, a card reader 36, a key switch 38S and a data display 37, are connected to the body PCB60. The lamp 30 is lit up in a predetermined pattern, based upon a control signal output from the main CPU41.

The hopper 66 is installed in the cabinet 11. This hopper pays out a predetermined number of coins from a coin payout exit 19 to a coin tray 18, based upon a control signal output from the main CPU41. A coin detecting section 67 is installed inside the coin payout exit 19. This detecting section outputs an input signal to the main CPU41 at the time of detecting that a predetermined number of coins have been paid out from the coin payout exit 19.

The graphic board 68 performs control, based upon a control signal output from the main CPU41. This graphic board displays images on the upper image display panel 33 and the lower image display panel 16 that serves as an output device. The activated paylines randomly determined through selection of random numbers are displayed, and also, symbols determined through selection of random number are displayed in a scrolling or stopped state, in the respective display blocks 28 on the lower image display panel 16. The number-of-credits display portion 31 on the lower image display panel 16 displays the number of credits stored in the RAM43. Further, the number-of-payouts display portion 32 on the lower image display panel 16 displays the number of coins to be paid out. The graphic board 68 is equipped with: a VDP (Video Display Processor), which generates image data based upon a control signal output from the main CPU41; and a video RAM, which temporarily stores image data generated by the VDP or the like. The image data used in generating image data with the VDP is read from the memory card 53. The read image data is contained in the game programs stored in the RAM43.

The bill validator 22 not only discriminates a valid bill from an invalid bill, but also accepts the valid bill into the cabinet 11. At the time of accepting a valid bill, the bill validator 22 outputs an input signal to the main CPU41 based upon a face amount of the bill. The main CPU41 stores the number of credits corresponding to the amount of the bill transmitted with the input signal.

The ticket printer 35, based upon a control signal output from the main CPU41, prints on a ticket a bar code obtained by encoding data such as the number of credits, date and time, and the identification number of the slot machine 10 stored in the RAM43. The printed bar-code ticket is output as the bar code-attached ticket 39. The card reader 36 transmits, to the main CPU41, the data read from the smart card, and writes the read data onto the smart card, based upon a control signal from the main CPU41. The key switch 38S is provided on the key pad 38, and outputs a predetermined input signal to the main CPU41 when a player operates the key pad 38. The data display 37 displays, based upon a control signal output from the main CPU41, the data read by the card reader 36 and the data input by a player through the key pad 38.

The control panel 20, a reverter 21S, a coin counter 21C, and a cold cathode-ray tube 81 are connected to the door PCB80. The control panel 20 is provided with: a SPIN switch 23S corresponding to the SPIN button 23; a CHANGE switch 24S corresponding to the CHANGE button 24; a CASHOUT switch 25S corresponding to the CASHOUT button 25; a 1-BET switch 26S corresponding to the 1-BET button 26; and a MAX-BET switch 27S corresponding to the MAX-BET button 27. When a player operates the buttons 23 to 27, the switches 23S to 27S corresponding thereto output input-signals to the main CPU41, respectively.

The coin counter 21C is installed inside the coin receiving slot 21. This coin counter discriminates whether a coin inserted by a player into the coin receiving slot 21 is valid or invalid. Those other than the valid coins are discharged from the coin payout exit 19. The coin counter 21C also outputs an input signal to the main CPU41 if a valid coin is detected.

The reverter 21S operates based upon a control signal output from the main CPU41 and distributes valid coins recognized by the coin counter 21C into a cash box (not shown) or the hopper 66, which is disposed in the slot machine 10. In other words, when the hopper 66 is filled with coins, valid coins are distributed into the cash box. On the other hand, when the hopper 66 is not filled with coins, valid coins are distributed into the hopper 66. The cold cathode-ray tube 81 works as a backlight installed on the back face side of each of the lower image display panel 16 and the upper image display panel 33. This backlight is lit up based upon a control signal output from the main CPU41.

FIG. 9 is a flowchart showing a subroutine of main processing. In the main processing, first, at step S101, the main CPU41 executes initial setting processing. Specifically, the main CPU41 executes the BIOS stored in the ROM42; decompresses, in the RAM43, the compressed data incorporated in the BIOS. Then, this CPU executes the BIOS decompressed in the RAM43 and diagnoses and initializes peripheral devices.

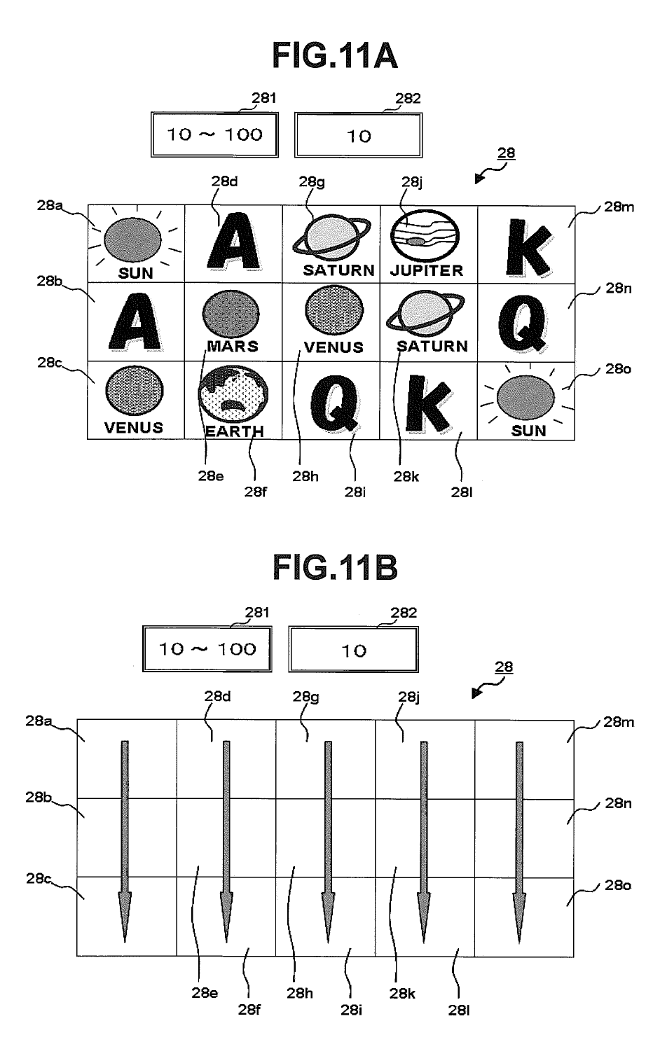

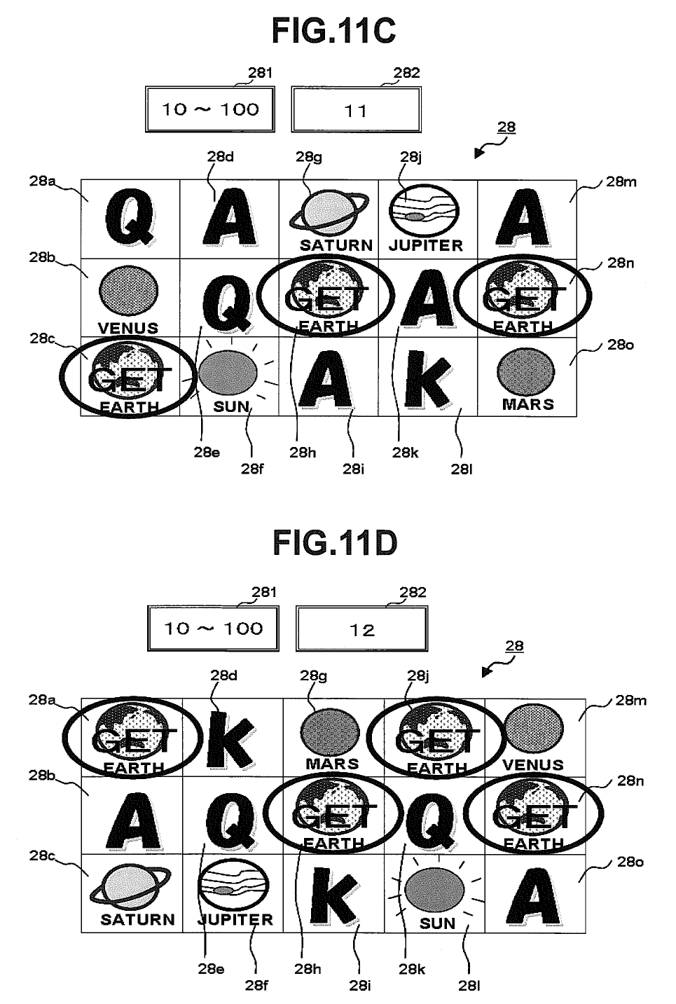

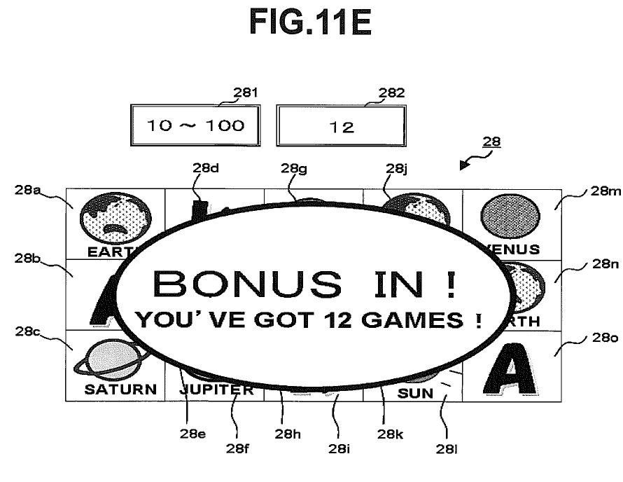

Next, at step S102, the main CPU41 executes processing of determining the number of times in winning BONUS. Specifically, the main CPU41 reads from the ROM42 the table for determining the number of times in winning BONUS, shown in FIG. 2, and then, randomly determines the specific number of times in winning BONUS from among the items of information concerning the range of the number of times in winning BONUS. In the present embodiment, as shown in FIG. 2, the range of the number of times in winning BONUS is between 10 and 100, and then, the specific number of times in winning BONUS (12, 25, 38, 73, or 87) is randomly determined from among the number of times in winning BONUS, ranging from 10 to 100. The specific number of times in winning BONUS is determined by selecting a predetermined random number value from among a plurality of random number values. In the present embodiment, 12 is determined as the specific number of times in winning BONUS. Then, the main CPU41 stores in the RAM43 the specific number of times in winning BONUS, which was randomly determined, and the items of information concerning the range of the number of times in winning BONUS. Further, the main CPU41 reads: the items of information concerning the range of the number of times in winning BONUS (10 to 100), which were stored in the RAM43; and displays the items of information concerning the range of the number of times in winning BONUS (10 to 100) at the display portion 281 for the range of the number of times in winning BONUS (see FIG. 11A).

Next, at step S103, the main CPU41 performs game execution processing shown in FIG. 10, which will be described later in detail.

Next, at step S104, the main CPU41 judges whether or not a reset processing flag is set to ON. Specifically, the main CPU41 judges whether or not reset processing of the specific number of times in winning BONUS is performed in the future game processing at step S20 and in payout processing of a progressive jackpot at step S21, of FIG. 10. Then, in a case where the main CPU41 judges that processing of resetting the specific number of times in winning BONUS is performed at step S21 or at step S22, this CPU reverts to step S102, and then, executes the processing of determining the number of times in winning BONUS again. After that, this CPU repeatedly executes the game execution processing at step S103. If the above judgment result at step S21 or S22 is negative, the main CPU41 repeatedly executes the game execution processing at step S103.

Next, the aforementioned game execution processing at step S103 will be described. FIG. 10 is a flowchart showing a subroutine of the game execution processing, which is identical to FIG. 1. FIGS. 11A to 11E are views each showing an exemplary display of symbols arranged on the display device.

At step S10, first, the main CPU41 judges whether or not coins have been betted. In this processing operation, the main CPU41 judges whether or not the input signal output from the 1-BET switch 27S has been received when the 1-BET button 26 has been operated; or alternatively, whether or not the input signal outputted from the MAX-BET switch 27S has been received when the MAX-BET button 27 has been operated. In a case where the main CPU41 judges that no coin has been betted (S10: NO), the routine reverts to step S10, and in a case where the CPU judges that coins have been betted (S10: YES), the routine proceeds to step S11.

Next, at step S11, in a case where it is judged that coins have been betted at step S10, the main CPU41 performs processing of subtracting the credit amount stored in the RAM43 in accordance with the number of betted coins. In addition, the main CPU41 performs processing of adding, in an accumulative manner, to the progressive value of the progressive jackpot that is a special prize in response to the number of coins betted by the BET buttons 26 and 27. Then, the main CPU41 stores the added progressive value in the RAM43. Therefore, the progressive values of the progressive jackpot are added in an accumulative manner, based upon the BET number, as described previously, so that the payout value of a coin with high payment is set.

Next, at step S12, the main CPU41 judges whether or not the SPIN button 23 has been set to ON. Specifically, the main CPU41 judges whether or not the input signal outputted from the SPIN switch 23S has been received when the SPIN button 23 has been depressed. In a case where the main CPU41 judges that the SPIN button 23 has not been turned ON (S12: NO), the routine reverts to step S10. In a case where the CPU41 judges that the SPIN button 23 has been set to ON (S12: YES) the routine proceeds to step S13. Where it is judged that the SPIN button 23 has not been turned ON (for example, where an instruction has been input to terminate a game without turning ON the SPIN button 23), the main CPU41 cancels acceptance of a credit amount subtraction result and a result of addition of a progressive value of step S11.

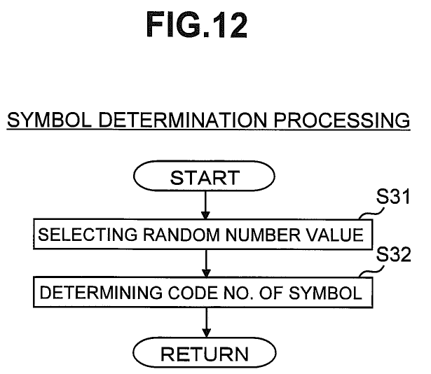

Next, at step S13, the main CPU41 performs symbol determination processing. Specifically, in a case of judging that the SPIN button 23 has been set to ON at step S12, the main CPU41 determines code Nos. at the time of stoppage of symbol scrolling by executing the symbol determination programs stored in the RAM43. This processing operation will be described later in detail with referring to FIG. 12. The present embodiment describes a case of determining one or plural prizes from among plural types of prizes by determining symbols displayed in a stopped state. However, the present invention is not limitative thereto, and, for example, may be applicable to a case in which one or more prizes selected from among the plural types of prizes are determined, and then, the combinations of symbols displayed in a stopped state are determined based upon the above-mentioned prizes.

Next, at step S14, the main CPU41 performs scroll-display processing. Specifically, the main CPU41 starts scroll-display of plural types of symbols, and then, controls the symbols determined at step S13 so as to be displayed in a stopped state in the display blocks 28, concurrently when the scroll-display is stopped after the elapse of a predetermined time. In the present embodiment, as shown in FIG. 11B, the scroll-display of the plural types of symbols is started in the direction indicated by the illustrative arrows.

Next, at step S15, the main CPU41 judges whether or not a scatter prize is established. Specifically, the main CPU41 judges whether or not three or more symbols for the scatter prize are displayed in a stopped state in any of display blocks 28, and the scatter prize is established. More specifically, this CPU judges whether or not three or more symbols of the same type are displayed based upon FIG. 7, in a stopped state from among “JUPITER”, “SATURN”, “SUN”, “VENUS”, “MARS”, “MERCURY”, “K”, “J”, “Q”, and “A”. In a case of judging that the scatter prize is established, based upon FIG. 7 (S15: YES), the main CPU41 proceeds to step S16 at which coin payout processing is performed. Where the judgment result is negative (S15: NO), this CPU proceeds to step S17 without performing coin payout.

Next, at step S16, the main CPU41 executes payout processing. Specifically, in a case where the main CPU41 judges that three or more trigger symbols for the scatter prize, of the same type, have been displayed in a stopped state at step S15, this CPU executes payout of a predetermined number of coins, which corresponds to the types and number of symbols displayed in a stopped state and the BET number, based upon FIG. 7. In the present embodiment, as shown in FIG. 11C, a total of four trigger symbols “A” for the scatter prize are rearranged in display blocks 28. Thus, the scatter prize is established, and then, coin payout according to the number of symbols “A” (four) is performed, based upon FIG. 7.

Next, at step S17, the main CPU41 judges whether a predetermined number of BONUS trigger symbols are displayed in a stopped state, and winning BONUS is established. The processing at step S17 is performed in a case where no scatter prize is established at step S15 (S15: NO), or alternatively, in a case where the coin payout processing exerted by establishment of the scatter prize at step S16 has completed. The main CPU41 judges whether or not three or more “EARTH” symbols serving as a trigger for BONUS have been displayed in a stopped state in any of the display blocks 28. In a case of judging that winning BONUS is established (S17: YES), the main CPU41 adds one count to the number of times in winning BONUS stored in the RAM43; stores in the RAM43 the number of times in winning BONUS again; and then, proceeds to step S19. If the judgment result is negative (S17: NO), this CPU terminates this subroutine. In a case of judging that winning BONUS is established (S17: YES), the CPU41 causes the win-count display portion 282 to display the number of times in winning BONUS, which were stored in the RAM43. In the present embodiment, as shown in FIG. 11C, three “EARTH” symbols serving as a BONUS trigger are displayed in a stopped state in the display blocks 28, thus allowing for judging that winning BONUS is established. The win-count display portion 282 displays the number of times (11) obtained by counting up the number of times in winning BONUS (10) stored in the RAM43.

In a case where the main CPU41 judges that no scatter prize is established at step S15 (S15: NO) and judges that no winning BONUS is established at step S17 (S17: NO), it is determined to be “losing”, which does not come under any of the prizes. The word “losing” used herein denotes a case in which no coin payout is performed.

Next, at step S18, the main CPU41 judges whether or not the number of times in winning BONUS, which was judged at step S17, reaches the specific number of times in winning BONUS (for example, 12), which was randomly determined at step S102 and stored in the RAM43. In FIG. 11D, four “EARTH” symbols serving as a trigger for winning BONUS are displayed in a stopped state in the display blocks 28, thus allowing for judging that winning BONUS is established. Then, the main CPU41 causes the win-count display portion 282 to display the number of times in winning BONUS (12) counted up from the previous number of times in winning BONUS (11). As shown in FIG. 11E, further, in a case where the number of times in winning BONUS reached the specific number of times in winning BONUS (for example, 12), which was randomly determined at step S102, the main CPU41 establishes “BONUS IN”, and then, displays, in the display blocks 28 of the lower image display panel 16, the items of information indicating that the number of times in winning BONUS for establishing “BONUS IN” was 12.

Next, at step S19, the main CPU41 performs BONUS lottery processing. Specifically, in a case where “BONUS IN” was established at step S18, the main CPU41 randomly determines the transition to a future game or the payout of a progressive jackpot, with referring to the BONUS lottery table shown in FIG. 4, which was stored in the ROM42. The main CPU41 determines either of the aforementioned future game and progressive jackpot by selecting a predetermined random number value from among the plurality of random number values shown in the BONUS lottery table.

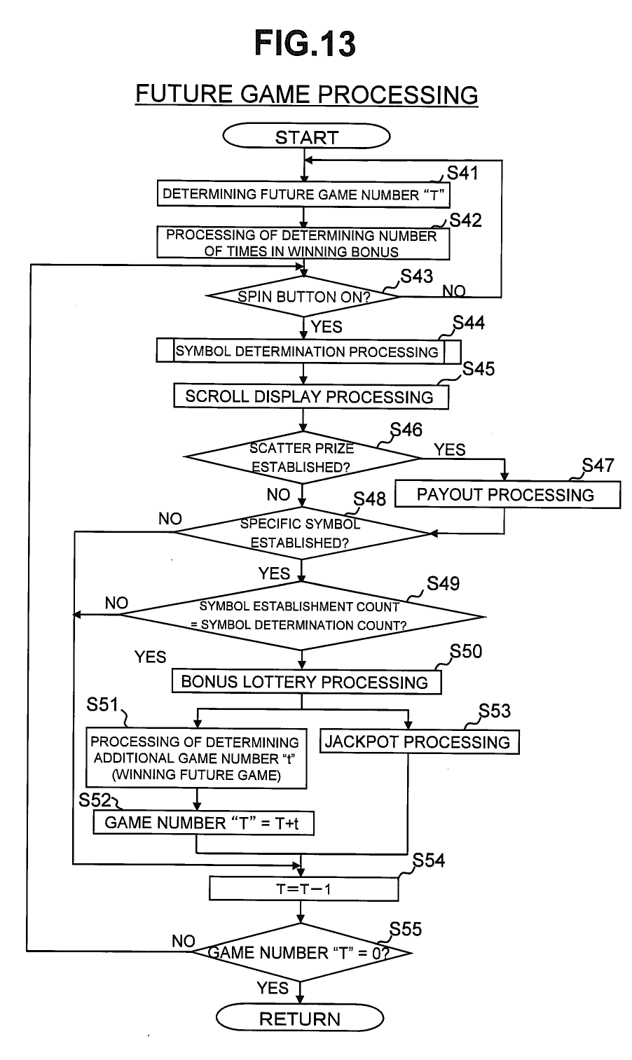

Next, at step S20, in a case where a future game was determined by the BONUS lottery processing of step S19, the main CPU41 executes future game processing. Specifically, upon executing future game processing, the main CPU41 reads a program for performing the future game from the RAM43. Then, upon starting the future game, the main CPU41 executes a random number generation program included in symbol determination programs to select a random number value. Further, this CPU executes free games by a predetermined number of times based upon the selected random number value. After executing the future game processing, the main CPU41 executes coin payout, based upon the payout number of coins acquired in the future game processing. After executing the future game processing, further, the main CPU41 sets a reset processing flag to ON, and then, resets to “0” the specific number of times in winning BONUS (for example, 12) stored in the RAM43. After that, the main CPU41 terminates this subroutine. The future game processing will be described later in detail with referring to FIG. 13.

Next, at step S21, in a case where a progressive jackpot was determined by the BONUS lottery processing of step S19, the main CPU41 executes jackpot processing. Specifically, the main CPU41 reads the progressive value stored in the RAM43 at step S11, and then, pays out a large amount of coins as a prize for the progressive jackpot, based upon the read progressive value. After paying out a predetermined number of coins, the main CPU41 terminates this subroutine. After completing the payout of the coins, the main CPU41 sets the reset processing flag to ON. Then, this CPU resets to “0” the progressive value stored in the RAM43 and the specific number of times in winning BONUS (for example, 12).

Next, symbol determination processing will be described. FIG. 12 is a flowchart showing a subroutine of symbol determination processing executed at step S13 shown in FIG. 7. This processing is performed by executing the symbol determination program stored in the RAM43.

First, at step S31, the main CPU41 executes processing of selecting a random number value. Specifically, the main CPU41 executes the random number generation program included in the symbol determination program, thereby selecting five random number values corresponding to each of the symbol columns (5 columns) from among the numeric values ranging from 0 to 255. The present embodiment describes a case in which random numbers are generated on a program (a case in which so-called software random numbers are employed). In the present invention, however, a random number generator is provided whereby random numbers may be extracted from the random number generator (so-called hardware random numbers may be employed).

Next, at step S32, the main CPU41 determines code Nos. of symbol columns (refer to FIG. 6), based upon the five random number values selected at step S31. The code Nos. of the symbol columns correspond to those of symbols displayed in a stopped state on the payline L. The main CPU 41 determines prizes by determining code Nos. of symbol columns. As shown in FIG. 6, for example, in a case where code Nos. of symbols have been determined to be “00”, “01”, “02”, “03”, and “04”, the corresponding prize is determined to be “EARTH”.

Next, future game processing will be described. FIG. 13 is a flowchart showing a subroutine of the future game processing executed at step S20, shown in FIG. 10. In the future game processing, a predetermined number of free games are performed without inputting a BET number by the BET button 26 or 27.

At step S41, first, the main CPU41 determines the future game (free game) number T executed in the future games. Specifically, the main CPU41 determines the number T of games from among 10 to 25 games, based upon the random number values obtained by executing the random number generation program stored in the RAM43. The main CPU41 stores, in the RAM43, data concerning the game number T executed in the thus determined future games.

Next, at steps S42 to S50, the main CPU41 performs: processing of determining the number of times in winning BONUS; SPIN button input judgment processing; symbol determination processing; scroll-display processing; processing of judging establishment of the scatter prize; processing of judging winning BONUS; processing of comparing and judging the number of times in winning BONUS and a specific number of times in winning BONUS, which was randomly determined; and BONUS lottery processing. A duplicate description of the processing operations at the steps S42 to S50 is omitted, since these operations are substantially identical to that of step S102 shown in FIG. 9 and those of steps S12 to S19 shown in FIG. 10.

Next, at step S51, in one future game, where another future game was determined by the BONUS lottery at step S50, the main CPU41 newly determines the repetition number “t” of future games (free games). At step S52, the main CPU41 adds the determined repetition number “t” at step S51 to the game number T in the current bonus game. Then, the main CPU41 stores in the RAM43 the game number T=(T+t) added at step S51. When more future games are won in a future game, the remaining game number in future games increases. Specifically, for example, in a case where the routine first proceeds to 20 future games, when 17 future games are won in a twelfth future game, 25 (20−12+17) future games are then performed.

Next, at step S53, in a case where a progressive jackpot is determined by BONUS lottery at step S50 in a future game, jackpot processing is executed in the future game. Specifically, the main CPU41 executes a large number of coin payout, based upon the progressive value of the RAM43 before transition to the future games.

Next, at step S54, the main CPU41 reads the game number T in the future games stored in the RAM43, and then, subtracts the value of the read game number T by 1. Then, the main CPU41 stores again in the RAM43 the game number T after subtracted.

Next, at step S55, the main CPU41 judges whether or not the game number T of future games reached the number of times determined at step S41. Specifically, the main CPU41 makes judgment in accordance with the fact that the game number T stored in the RAM43 was set to 0. In a case where the game number T is not set to 0 (S55: NO), i.e., in a case of judging that the number of times in executing future games has not reached the game number determined at step S41, the CPU41 reverts to step S43, and then, repeats the processing operations of steps S43 to S55 mentioned above. In a case where the judgment result is affirmative (S55: YES), i.e., in a case where it is judged that the number of times determined at step S41 has been reached, the main CPU41 terminates this subroutine.

In the slot machine 10 and playing method thereof, according to the present embodiment, when a game is started, a specific number of times in winning BONUS (12, 25, 48, 73, or 87) is randomly determined from among items (10 to 100) of information concerning the number of times in winning BONUS, with referring to the table for determining the number of times in winning BONUS, shown in FIG. 2, which was stored in the ROM42. In addition, the determined specific number of times in winning BONUS (for example, 12) and the items (10 to 100) of information concerning a range of the number of times in winning BONUS are stored in the RAM43. Then, plural types of symbols arranged in the display blocks 28 of the lower image display panel 16 are automatically rearranged. Further, it is judged whether three or more trigger symbols for the scatter prize are displayed in a stopped state in any of the rearranged display blocks 28 and the scatter prize is established or whether three or more trigger symbols for the scatter prize are displayed in a stopped state and winning BONUS is established. In a case where it is judged that the scatter prize is established as the result of judgment, a predetermined number of coins are paid out according to the number of displayed symbols. Where it is judged that winning BONUS is established as the result of judgment, the winning BONUS is counted as one count and the counted number of times is stored in the RAM43. After the number of times in winning BONUS stored in the RAM43 is randomly determined, where the determined number reached the specific number of times in winning BONUS (for example, 12) stored in the RAM43, as the result of repeating games, “BONUS IN” is established. When “BONUS IN” is established, BONUS lottery processing is executed, determining transition to future games or payout of the progressive jackpot. When either of them is determined, the corresponding prize is awarded to a player.

The items of information (10 to 100) concerning the range of the number of times in winning BONUS, which was stored in the RAM43 in games, and the current total number of times in winning BONUS, are displayed at the win-count range display portion 281 and the win-count display portion 282, of the lower image display panel 16.

In this manner, in the slot machine 10 and playing method thereof, according to the present invention, prizes are awarded in a case where the specific number of times in winning BONUS has been reached, so that the player can continuously enjoy the play of games for the specific number of times in winning BONUS. Further, the specific number of times in winning BONUS is randomly determined, so that a variety of the number of times in winning BONUS can be provided.

The win-count display portion 282 displays the current total number of times in winning BONUS, thus allowing a player to keep track of the current total number of times in winning BONUS and to continuously have the feeling of excitement that future games or progressive jackpots are awarded.

The win-count range display portion 281 displays the number of times in winning BONUS, thus allowing the player to keep track of the range of the number of winning times until future games or progressive jackpots are awarded.

While the above-mentioned example described a single range of the items (10 to 100) of information concerning the range of the number of times in winning BONUS, the present invention is not limitative thereto, and a plurality of ranges of the number of times in winning BONUS may be set. For example, a range of 10 to 100 and a range of 101 to 200 may be set. In this case, the range of the specific number of times in winning BONUS may be randomly determined from among the plurality of ranges of the number of times in winning BONUS.

While the above-mentioned example described a case in which the condition for counting the number of times in winning BONUS was that a predetermined number of predetermined symbols were arranged, the present invention is not limitative thereto, and the predetermined combinations of symbols may be arranged.

While, in the above-mentioned example, the number of times in wining BONUS was merely counted, the present invention is not limitative thereto. It may be possible to count the number of times in winning BONUS every time winning BONUS is established and to award a predetermined payment according to such winning BONUS.

While the above-mentioned example described a case in which the condition for counting the number of times in winning BONUS was that three or more (3, 4, or 5) specific symbols were displayed in a stopped state, the present invention is not limitative thereto. For example, in counting the number of times in winning BONUS, in the case of three, four, or five specific symbols, one, two, or three counts may be established, respectively.

While the above-mentioned example described a case in which the condition for counting the number of times in winning BONUS was that three or more “EARTH symbols (3, 4, or 5) were displayed in a stopped state, the present invention is not limitative thereto. For example, in counting the number of times in winning BONUS, in the case of three or more “VENUS”, “SATURN”, and “EARTH” symbols, one, two, or three counts may be established, respectively. In this case, it may be possible to set predetermined values on a symbol-type basis; count winning prizes by types of symbols; and then, award the prizes after comparing the count value and a predetermined value, respectively. In this case, further, a win-count display portion, according to types of symbols, and a win-count range display portion may be provided.

While the above-mentioned example described that the current total number of times in winning BONUS and the items of information concerning the range of the number of times in winning BONUS were displayed anytime in games, the aforementioned display may be performed, for example, in a case where a predetermined condition is established (for example, when winning BONUS is established).

While the above-mentioned example described a case of displaying the current total number of times in winning BONUS and the items of information concerning the range of the number of times in winning BONUS, the present invention is not limitative thereto. A symbol display portion for winning BONUS may be provided in order for the player to keep track of symbols for winning BONUS.

While the above-mentioned example described that either of first and second prizes were awarded by BONUS lottery processing, the present invention is not limitative thereto. In a case where the number of times in winning BONUS reached the randomly determined specific number of times in winning BONUS, any prizes may be automatically awarded without performing the BONUS lottery processing.

While the above-mentioned example described that the current number of times in winning BONUS was stored in the RAM43, for example, the number of times in winning BONUS stored in the RAM43 may be automatically initialized in a case where a predetermined time has elapsed after the player has terminated games in the slot machine. Further, a reset input device is provided so that the number of times in winning BONUS stored in the RAM43 may be forcibly initialized by the player's operation.

While the above-mentioned example described a case in which the number of times in winning BONUS reached the randomly determined specific numeric value, the present invention is not limitative thereto, and may be applicable to a case in which the specific number of effect display times reached the randomly determined specific numeric value. In this case, controlling is performed as follows. With referring to a table for determining the number of effect display times, which was stored in a ROM, the main CPU randomly determines a specific number of effect display times (11, 24, 32, 46, and 50) from items of information (10 to 50) concerning the range of the number of effect display times. In addition, this CPU stores in the RAM the determined specific number of effect display times (for example, 11) and the items of information (10 to 50) concerning the range of the number of effect display times. Then, the main CPU automatically rearranges plural types of symbols arranged in display blocks of the lower image display panel. Further, the main CPU judges whether or not winning prizes are established in any of the rearranged display blocks. As the result of repeating the number of times in executing games, in a case where it is judged that winning prizes are established as the result of the above judgment, this CPU awards a predetermined payment. In a case where a specific effect display is established on the lower image display panel in at least one of the processing operations described above, the main CPU counts the specific number of effect display times and stores the counted number of times in the RAM. As the result of repeating games, in a case where the specific number of effect display times, which was stored in the RAM43, reached the specific number of effect display times that was randomly determined and stored in the RAM43 (for example, 11), the main CPU awards a predetermined prize. It is preferable to display the current number of effect display times, which was stored in the RAM, and the items of information (10 to 50) concerning the range of the number of effect display times.

While the above-mentioned example described a case in which a total of 15 symbols in 5 columns and 3 rows were displayed, the display format of symbols in the present invention is not limitative to that of 5 columns and 3 rows, and is applicable to a variety of display formats such as that of 3 columns and 3 rows. Further, while the above-mentioned example described a case in which symbols were displayed in a scrolled manner in each of the display block columns, each of these symbols may be individually displayed in a scrolled manner.

While the above-mentioned example described that the symbols were displayed in a scrolled manner with the use of a liquid crystal display device or the like, the present invention is not limitative thereto. In a case where mechanical reels are employed, the symbols may be expressed and displayed on the surfaces thereof.

While the embodiment according to the present invention has been described, the description presents only some of the specific examples and is not intended to limit the present invention in any way and specific constructions of each means and the like can be properly changed in terms of design. Besides, the effects described in the embodiment of the present invention are only the most preferable effects generated from the present invention and the effects to be caused by the present invention is not limitative thereto.

The more important features of the invention have thus been outlined, rather broadly, in order that the aforementioned detailed description thereof may be better understood, and in order that the present contribution to the art may be better appreciated. There are, of course, additional features of the invention that were described above and which formed the subject matter of the claims appended hereto. In this respect, upon explaining at least one embodiment of the invention in detail, it is to be understood that the invention is not limitative in its application to the details of construction and to the arrangements of the components set forth in the aforementioned description or illustrated in the drawings. According to the invention, other embodiments can be variously practiced and carried out as well. Also, it is to be understood that the phraseology and terminology employed herein are merely intended for the descriptive purpose and should not be regarded as limiting. As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These matters together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matters in which there are illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art. A procedure is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities. Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices. The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general-purpose machines may be used with programs written in accordance with the teachings herein, or it may prove more convenient to construct more specialized apparatus to perform the required method steps. The required structure for a variety of these machines will appear from the description given.

What is claimed is:

1. A slot machine, comprising:
a display device on which plural types of symbols are arranged;
at least one memory; and
a controller,
the controller being configured to:
store at least one item of predetermined numeric range information in the memory;
(i) randomly determine a specific numeric value from among the predetermined numeric range information stored in the memory and store the determined specific numeric value in the memory;
(ii) automatically rearrange the plural types of symbols arranged on the display device;
(iii) judge whether a state of rearrangement of predetermined symbols is established on the symbol-rearranged display device;
(iv) count one state of rearrangement of the predetermined symbols as one count and store the counted number of times in the memory in a case where it is judged that the state of rearrangement of the predetermined symbols is established, as a result of the judgment in the itemized (iv); and
(v) award prizes having predetermined values in a case where the number of times in establishing the state of rearrangement of the predetermined symbols stored in the itemized (v), reaches the specific numeric value stored in the itemized (ii), as a result of repeating processing in the itemized (iii) to (v).

2. The slot machine according to claim 1, wherein:
the controller, in the itemized (v), counts the state of rearrangement of the predetermined symbols as one count in a case where it is judged that the state of rearrangement of the predetermined symbols is established; causes the memory to store the counted number; and causes the display device to display the stored number of times in establishing the states of rearrangement of the predetermined symbols.

3. The slot machine according to claim 1, wherein:
the controller causes the display device to display the predetermined numeric range information stored in the memory in the itemized (i).

4. The slot machine according to claim 1, wherein:
the controller, in the itemized (iv), further includes processing of causing the display device to display information concerning the specific numeric value in a case where the number of times in establishing the state of rearrangement of the predetermined symbols, stored in the itemized (v), reaches the specific numeric value stored in the itemized (ii), as a result of repeating processing in the itemized (iii) to (v).

5. The slot machine according to claim 1, further comprising an input device for inputting a BET, wherein: when the BET is input from the input device on a one-by-one game basis, the controller counts the input BET, causes the memory to store the counted BET number, and adds the stored BET number to the predetermined value of the prizes in the itemized (iv).

6. The slot machine according to claim 1, wherein:
the controller causes the memory to store a plurality of predetermined numeric range information; randomly determines one item of predetermined numeric range information from among the plurality of the stored predetermined numeric range information; randomly determines a specific numeric value from among the determined predetermined numeric range information; and causes the memory to store the determined specific numeric value.

7. The slot machine according to claim 1, wherein:
the controller, in the itemized (v), further includes processing of giving a payment based upon the state of rearrangement of the predetermined symbols, in a case where it is judged that the state of rearrangement of the predetermined symbols is established as a result of the judgment in the itemized (iv).

8. The slot machine according to claim 1, wherein:
the prizes, in the itemized (vi), include a first prize and a second prize; and
the controller, in the itemized (vi), awards either of the first prize and the second prize by internal lottery in a case where the number of times in establishing a state of rearrangement of the predetermined symbols, which are stored in the itemized (v), reaches the specific numeric value stored in the itemized (ii), as a result of repeating processing in the itemized (iii) to (v).

9. The slot machine according to claim 1, wherein:
the state of rearrangement of the predetermined symbols is a state in which a combination of the predetermined symbols is realized or a predetermined number of predetermined symbols are rearranged.

10. The slot machine according to claim 1, wherein:
the controller initializes the specific numeric value stored in the memory in the itemized (ii) in a case where processing in the itemized (iii) is not repeatedly performed, based upon a player's instruction, after processing in the itemized (v).

11. The slot machine according to claim 1, comprising a reset input device for initializing the specific numeric value stored in the itemized (ii), wherein the controller initializes the specific numeric value stored in the memory in the itemized (ii) in a case where a player performs input from the reset input device.

12. A slot machine, comprising:
a display device on which plural types of symbols are arranged and a specific effect display is established;
at least one memory; and
a controller,
the controller being configured to:
(i) store at least one item of predetermined numeric range information in the memory;
(ii) randomly determine a specific numeric value from among the predetermined numeric range information stored in the memory and store the determined specific numeric value in the memory;
(iii) automatically rearrange the plural types of symbols arranged on the display device;
(iv) judge whether a state of rearrangement of predetermined symbols is established on the symbol-rearranged display device;
(v) give a predetermined payment in a case where it is judged that the state of rearrangement of the predetermined symbols is established, as a result of the judgment in the itemized (iv);
(vi) count the number of times in establishing the specific effect display and store the counted number of times in the memory in a case where the specific effect display is established on the display device, in at least one of processing operations in the itemized (iii) to (v); and
(vii) award prizes having predetermined values in a case where the number of times in establishing the specific display stored in the itemized (vi) reaches the specific numeric value stored in the itemized (ii), as a result of repeating processing operations in the itemized (iii) to (vi).

13. The slot machine according to claim 12, wherein:
the controller, in the itemized (iv), counts the number of times in establishing the specific effect display in a case where the specific effect display is established on the display device in at least one of processing operations in the itemized (iii) to (v); causes the memory to store the counted number of times; and causes the display device to display the stored number of times in establishing the specific effect display.

14. The slot machine according to claim 12, wherein:
the controller causes the display device to display the predetermined numeric range information stored in the memory.

15. The slot machine according to claim 12, wherein:
the controller, in the itemized (vii), further includes processing of causing the display device to display information concerning the specific numeric value in a case where the number of times in establishing the specific effect display, stored in the itemized (vi), reaches the specific numeric value stored in the itemized (ii), as a result of repeating processing operations in the itemized (iii) to (vi).

16. A slot machine playing method, comprising the steps of:
(i) storing at least one item of predetermined numeric range information in the memory;
(ii) randomly determining a specific numeric value from among the predetermined numeric range information stored in the memory and storing the determined specific numeric value in the memory;
(iii) automatically rearranging the plural types of symbols arranged on the display device;
(iv) judging whether a state of rearrangement of predetermined symbols is established on the symbol-rearranged display device;
(v) counting the state of rearrangement of the predetermined symbols as one count and storing the counted number of times in the memory in a case where it is judged that the state of rearrangement of the predetermined symbols is established as a result of the judgment in the step (iv); and
(vi) awarding prizes having predetermined values in a case where the number of times in establishing the state of rearrangement of the predetermined symbols, which is stored in the step (v), reaches the specific numeric value stored in the step (ii), as a result of repeating the steps (iii) to (v).

17. The slot machine playing method according to claim 16, wherein:
in a case where it is judged that the state of rearrangement of the predetermined symbol is established as a result of the judgment in the step (v), the state of rearrangement of the predetermined symbols is counted on a one-by-one game basis and the counted number of times is stored in the memory, and then, the stored number of times in establishing the state of rearrangement of the predetermined symbols is displayed on the display device.

18. The slot machine playing method according to claim 16, further comprising the step of causing the display device to display the predetermined numeric range information stored in the memory in the step (i).

19. The slot machine playing method according to claim 16, further comprising the step of, in the step (vi), in a case where the number of times in establishing the state of rearrangement of the predetermined symbols are arranged, which is stored in the step (v), reaches the specific numeric value stored at the step (ii), as a result of repeating the steps (iii) to (v), causing the display device to display information concerning the specific numeric value.

20. The slot machine playing method according to claim 16, further comprising the step of, when a BET number is input from an input device one a one-by-one game basis, counting the input BET number, causing the memory to store the counted BET number, and adding the stored BET number to the predetermined values of the prizes in the step (vi).
